(19) United States
(12) Patent Application Publication
(10) Pub. No.: US 2026/0245991 A1
(43) Pub. Date: Aug. 20, 2026

(54) BATTERY PACK

(71) Applicant: MILWAUKEE ELECTRIC TOOL CORPORATION, Brookfield, WI (US)

(72) Inventors: James D. Lorenz, Wauwatosa, WI (US); Daniel A. Peters, Elkhorn, WI (US)

(21) Appl. No.: 19/538,400

(22) Filed: Feb. 12, 2026

Related U.S. Application Data
(60) Provisional application No. 63/758,409, filed on Feb. 14, 2025.

(51) Int. Cl. H01M 10/42; H01M 50/209; H01M 50/262

(52) U.S. Cl. CPC H01M 10/425; H01M 50/209; H01M 50/262

(57) ABSTRACT

A battery pack includes a battery terminal configured to be connected to a tool, a battery cell electrically coupled to the battery terminal, a latch actuatable to selectively secure the battery pack to a tool, a housing enclosing at least a portion of the latch, and a subhousing positioned at least partially within the housing. The subhousing includes a latch cover portion enclosing at least a portion of the latch therein and a terminal cap portion enclosing at least a portion of the battery terminal. The subhousing is integrally formed as a single part.

### CROSS-REFERENCE TO RELATED APPLICATIONS

This application claims priority to U.S. Provisional Patent Application No. 63/758,409 filed on Feb. 14, 2025, the entire contents of which are hereby incorporated by reference herein.

### FIELD

The present disclosure relates to battery packs, and more particularly to battery pack housings.

### SUMMARY

In one independent aspect, a battery pack includes a battery terminal configured to be connected to a tool; a battery cell electrically coupled to the battery terminal; a latch actuatable to selectively secure the battery pack to a tool; and a housing enclosing at least a portion of the latch; and a subhousing positioned at least partially within the housing, the subhousing including a latch cover portion enclosing at least a portion of the latch therein and a terminal cap portion enclosing at least a portion of the battery terminal; wherein the subhousing is integrally formed as a single part.

In another independent aspect, a battery pack includes a battery terminal configured to be connected to a tool; a battery cell electrically coupled to the battery terminal; a latch actuatable to selectively secure the battery pack to the tool; and a housing enclosing at least a portion of the latch and including at least one housing portion and a core within the housing portion defining a void within which the battery cell is positioned; a latch cover enclosing at least a portion of the latch therein; and a terminal cap enclosing at least a portion of the battery terminal; wherein at least one of the latch cover and the terminal cap is ultrasonically welded to either the housing portion or the core.

In another independent aspect, a battery pack includes a control circuit board; a light emitting component coupled to the control circuit board; a battery terminal electrically coupled to the control circuit board; a battery cell electrically coupled to the battery terminal; a latch actuatable to selectively secure the battery pack to a tool; and a housing enclosing the control circuit board and the light emitting component at least partially therein, the housing including a light guide hole passing from an interior of the housing to an exterior of the housing; a latch cover positioned at least partially within the housing, the latch cover enclosing at least a portion of the latch therein; wherein the latch cover is made of a transparent material and further includes a light guide portion extending in a direction from the light emitting component in the interior of the housing and through the light guide hole such that light emitted by the light emitting component is transmitted through the light guide portion and is visible from the exterior of the housing.

Other aspects of the disclosure will become apparent by consideration of the detailed description and accompanying drawings.

### BRIEF DESCRIPTION OF THE DRAWINGS

FIG. 1 is a perspective view of a battery pack latch cover and terminal cap according a known embodiment.

FIG. 2 a perspective view strain diagram illustrating strain on the latch cover and terminal cap of FIG. 1 in response to an impact.

FIG. 3 is a top perspective view of a battery pack subhousing including a latch cover portion and a terminal cap portion in accordance with embodiments disclosed herein.

FIG. 4 is bottom perspective view strain diagram illustrating strain on the subhousing of FIG. 3 in response to an impact.

FIG. 5 is a top perspective view of a battery pack and the battery pack subhousing of FIG. 3.

FIG. 6 is a bottom perspective view of the battery pack subhousing of FIG. 3 and a first housing portion.

FIG. 7 is a perspective view of the battery pack of FIG. 5 viewed from section line 7-7 in FIG. 5.

FIG. 8 is a cross-sectional view of an alternate latch cover.

FIG. 9 is a bottom view of the alternate latch cover of FIG. 8.

FIG. 10 is a bottom perspective view of a battery pack and the alternate latch cover of FIG. 8.

FIG. 11 is a top perspective view of the alternate latch cover of FIG. 8.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

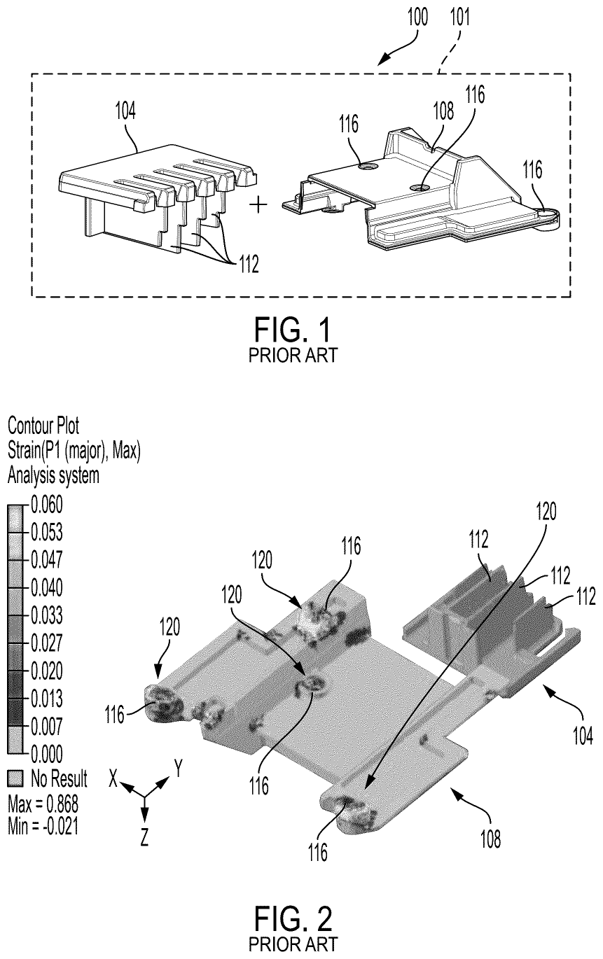

FIGS. 1-2 illustrate a known battery pack 100 including a housing 101, a terminal cap 104 and a latch cover 108 that are disconnected from one another and at least partially positioned within the housing 101. The terminal cap 104 includes a plurality of terminal spacing ribs 112. The latch cover 108 defines a plurality of receptacles 116 configured to receive fasteners (not shown) to secure the latch cover 108 to the housing 101.

FIG. 2 illustrates strain concentration upon impact of the battery pack 100 to an external surface. High strain concentration locations 120 are present near each of the plurality of receptacles 116. The terminal cap 104 observes little to no strain.

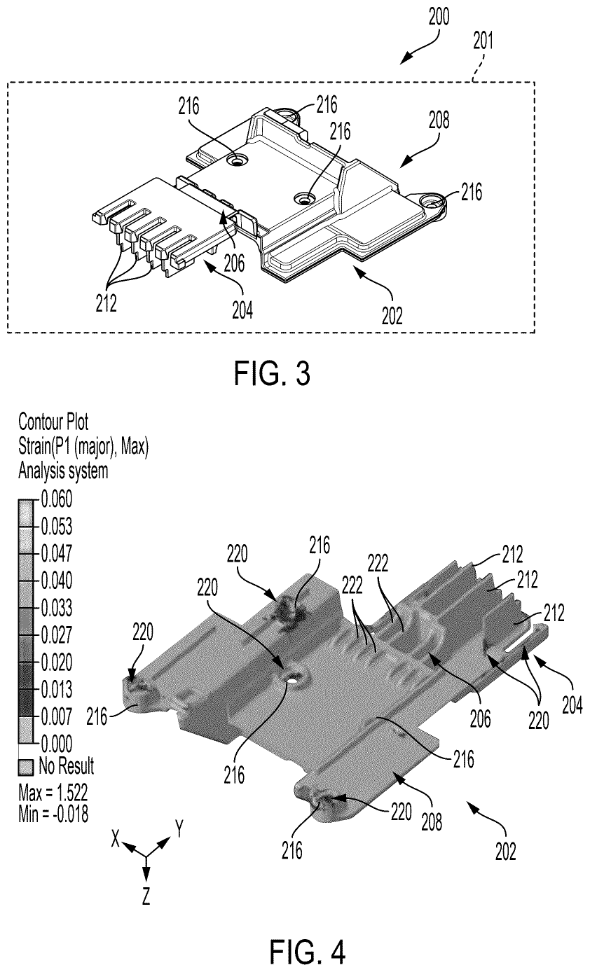

FIGS. 3-6 illustrate a battery pack 200 in accordance with the proposed design. The battery pack 200 includes a housing 201, and a subhousing 202 including a terminal cap portion 204, a latch cover portion 208, and a bridge portion 206 interconnecting the terminal cap portion 204 and the latch cover portion 208. The terminal cap portion 204 includes terminal spacing ribs 212. The latch cover portion 208 includes a plurality of receptacles 216 configured to receive fasteners 232 to secure the latch cover portion 208 to the housing 201. The bridge portion 206 includes a plurality of structural support ribs 222. The structural support ribs 222 are generally planar, are spaced from one another, and are connected to both the terminal cap portion 204 and the latch cover portion 208.

Components of the subhousing 202, more specifically, the terminal cap portion 204, bridge portion 206, and latch cover portion 208 are integrally formed with one another as one part. In the illustrated embodiment, the subhousing 202 is formed by injection molded plastic. As a result of integrally forming the subhousing 202, part count of the battery pack 200 is decreased in comparison with the battery pack 100. Integrally forming the terminal cap portion 204, bridge portion 206, and latch cover portion 208 reduces complexity of assembly of the battery pack 200 in comparison with the battery pack 100. However, components of the subhousing 202 may be otherwise formed and connected to one another prior to assembly of the battery pack 200.

In other embodiments, the subhousing 202 may be made of a different material in comparison to the housing 201. The subhousing 202 may be made of a higher thermal resistance and a more wear resistant material in comparison to the housing portions 201a, 201b, and the core 201c. By applying high thermal resistance and wear resistant material to the subhousing 202 but not the housing portions 201a, 201b, and core 201c, cost savings can be realized since cheaper less thermally resistive and less wear resistant material (as appropriate) can be used for the housing portions 201a, 201b and core 201c, and the battery pack 200 may accommodate higher temperatures of the terminals T and also provide greater resistance of sustained wear of the latches 228 and/or other components generated during vibration during use of the battery pack 200. Similarly, high quality surface finish properties can be applied to exterior surfaces of the housing portions 201a, 201b that are exposed to an exterior surface of the battery pack 200 and are regularly touched. The high quality surface finish need not be applied to the subhousing 202 since the subhousing 202 is generally within the housing 201 and is not typically touched.

FIG. 4 illustrates strain concentration upon impact of the battery pack 200 to an external surface. Strain concentration locations 220 are present near each of the plurality of receptacles 216, but are less concentrated and have less peak strain in comparison with the high strain concentration locations 120. Further, strain concentration locations 220 are present on the terminal cap portion 204 near the terminal spacing ribs 212. The bridge portion 206 effectively causes impact load of the battery pack 200 to be shared by both the terminal cap portion 204 and the latch cover portion 208 and to relieve stress on the receptacles 216. In other words, a portion of the impact load can be shared by both the terminal cap portion 204 and the latch cover portion 208.

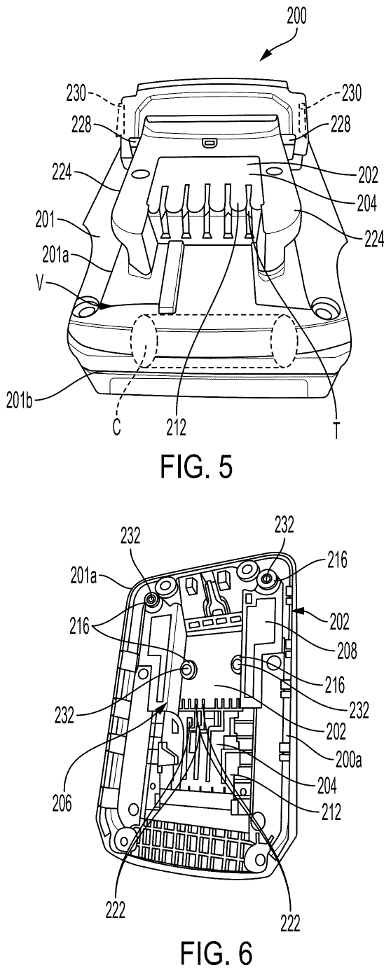

FIGS. 5-6 further illustrate the battery pack 200 as including a pair of rails 224 configured to slidably engage either a charger or a tool to electrically connect battery terminals T of the battery pack 200 to the charger or tool (not shown). The battery terminals T are positioned between adjacent terminal spacing ribs 212 at least partially within the terminal cap portion 204. In other words, the battery terminals T are at least partially enclosed therein by the terminal spacing ribs 212.

The battery pack 200 further includes latches 228 partially positioned within the latch cover portion 208. The latches 228 are positioned adjacent the rails 224 such that insertion of the battery pack 200 into the charger or tool causes the latches 228 to engage the charger or tool. The latches 228 are connected to user input buttons 230 that are accessible from an exterior of the housing 201. The user input buttons 230 may be actuated (i.e., moved) to cause movement and corresponding disengagement (and movement) of the latches 228 from the charger or tool and permit the battery pack 200 to be removed from the charger or tool. The user input buttons 230 may be biased to engage the latches 228 with the charger or tool. The user input buttons 230 may deflect the latches 228 to move between the engaged position and a disengaged position to selectively secure the battery pack 200 to the charger or tool. Optionally, the user latches 228 engage the latch cover portion 208.

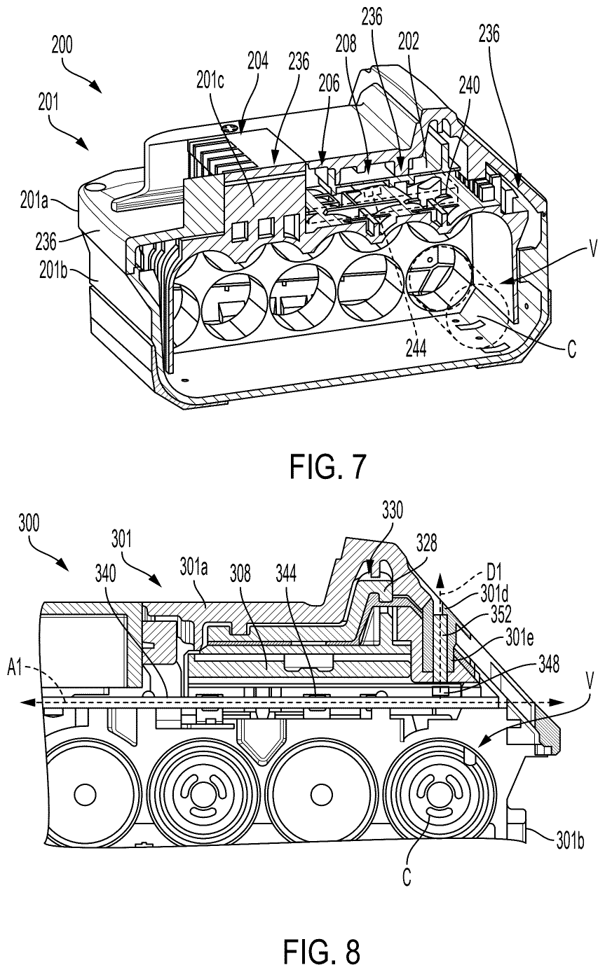

The illustrated housing 201 includes a first housing portion 201a and a second housing portion 201b connected to one another. The first housing portion 201a generally forms a top of the battery pack 200 by providing the rails 224. The second housing portion 201b generally forms a bottom of the battery pack 200. The illustrated housing 201 further includes a core 201c (FIG. 7) within the first housing portion 201a and the second housing portion 201b. The core 201c defines a void V within which a battery cell C is positioned. The battery cell C may be a cylindrical type battery cell, a pouch cell, or any other type of cell. The battery pack 200 may include a plurality of cells C. The illustrated battery pack 200 includes ten cells C. The cells C may be coupled in series. Each cell C of the illustrated battery pack 200 has a voltage of approximately 3.4 volts to 3.7 volts, and the total voltage of the battery pack 200 including parallel strings of cells C is approximately 18 volts. Other arrangements of cells C, numbers of cells C, voltages of individual cells C, and/or the total voltage of the battery pack 200 may differ in other embodiments. Cell or cells C of the battery pack 200 are electrically coupled to at least the battery terminals T. In some embodiments, the core 201c may separate battery cells C from one another within the housing 201. The illustrated core 201c separates the battery cells C from the control circuit board 240.

As shown in FIG. 7, the cells C may be coupled to a control circuit board 240 (FIG. 7). The control circuit board 240 be electrically coupled to one or more electronic components 244. One or more of the electronic components 244 may be mounted on a surface of the control circuit board 240. Exemplary one or more electronic components 244 may include but are not limited to a voltage sensor, current sensor, thermistor, or the like for monitoring operational status of the battery pack 200 and/or the connected tool or charger. By providing an integrally formed subhousing 202, quantity of impact load passed to (i.e., transmitted to, transferred to) the one or more electronic components 244 can be inhibited. The control circuit board 240 may be arranged between the latch cover portion 208 and the void V defined by the second housing portion 201b (see FIG. 8).

FIG. 7 further illustrates the latch cover portion 208 mechanically coupled to the first housing portion 201a by an ultrasonic weld 236 and the terminal cap portion 204 mechanically coupled to the housing 201 by a different ultrasonic weld 236. More specifically, a lower surface of terminal cap portion 204 is ultrasonically welded to an upper surface of first housing portion 201a, and an upper surface of the latch cover portion 208 is ultrasonically welded to a lower surface of first housing portion 201a. Further, the first housing portion 201a is mechanically coupled to the second housing portion 201b by ultrasonic welds 236. In other embodiments, the terminal cap portion 204 and latch cover portion 208 need not be integrally formed as a single piece of a subhousing 202 for the ultrasonic welds 236 to separately secure the terminal cap portion 204 to the housing 201 and the latch cover portion 208 to the housing 201. With any integrally formed or separately formed arrangement, the ultrasonic welds 236 permit impact load of the battery pack 200 and an external surface to be shared by interconnected components secured to one another by the ultrasonic welds 236. For example and as illustrated in FIG. 7, impact load of the battery pack 200 and the external surface can be shared by the first housing portion 201a, second housing portion 201b, terminal cap portion 204, and bridge portion 206 via the ultrasonic welds 236. Additionally or alternatively, one or more ultrasonic welds 236 may be secure the subhousing 202 to the core 201c. As a result, the first housing portion 201a, second housing portion 201b, core 201c, and subhousing 202 may be connected to one another directly or indirectly by one or more ultrasonic welds 236. In the illustrated embodiment, an ultrasonic weld 236 secures the terminal cap portion 204 to the core 201c. At a separate location, another ultrasonic weld 236 secures the latch cover portion 208 to the first housing portion 201a. Other arrangements of the ultrasonic welds 236 are possible.

FIG. 8 illustrates a battery pack 300 with components thereof similar to the battery pack 200 and with reference numerals in the ‘300’ series. Rather than an integrally formed subhousing 202, the battery pack 300 has a distinct latch cover 308 similar to the latch cover 108. In other embodiments, the latch cover 308 may be integrally formed as a single part with a terminal cap (e.g., as in the subhousing 202 with the terminal cap portion 204).

With either arrangement (integrally formed or discretely formed latch cover), a light emitting component 348 (e.g., light emitting diode, LED) is present within the housing 301. The light emitting component 348 may be mechanically and/or electrically coupled to the control circuit board 340. The light emitting component 348 may receive electrical power from the battery cell C, and may emit light indicative of a state of charge (SOC) of the battery cell C. The housing 301 may include a light guide hole 301d passing from an interior of the housing 301 to an exterior of the housing 301. The latch cover 308 may be made of a transparent material and include a light guide portion 352 extending from the light emitting component 348 and at least to the light guide hole 301d such that light emitted by the light emitting component 348 is transmitted through the light guide portion 352 and is visible from the exterior of the housing 301. As illustrated in FIG. 8, the control circuit board 340 is generally planar about plane A1, with the light emitting component 348 mounted on a surface thereof facing upward as viewed in FIG. 8. In the illustrated embodiment, the light guide portion 352 extends in a direction D1 oriented perpendicular from the control circuit board 340. Other light guide portions 352 may extend in other directions relative to the control circuit board 340 (e.g., other light guide portions 352 may extend transverse or parallel to the control circuit board 340). In other words, the light guide portion light guide portion 352 extends perpendicularly from the plane A1 defined by the control circuit board 340. The light guide hole 301d extends along the same direction D1. Optionally, as illustrated in FIG. 8 the housing 301 may include a light guide support channel 301e surrounding the light guide portion 352 and extending from the housing 301 back towards the light emitting component 348 in reverse of the direction D1 (i.e., opposite the direction D1), with the light guide hole 301d extending through the light guide support channel 301e.

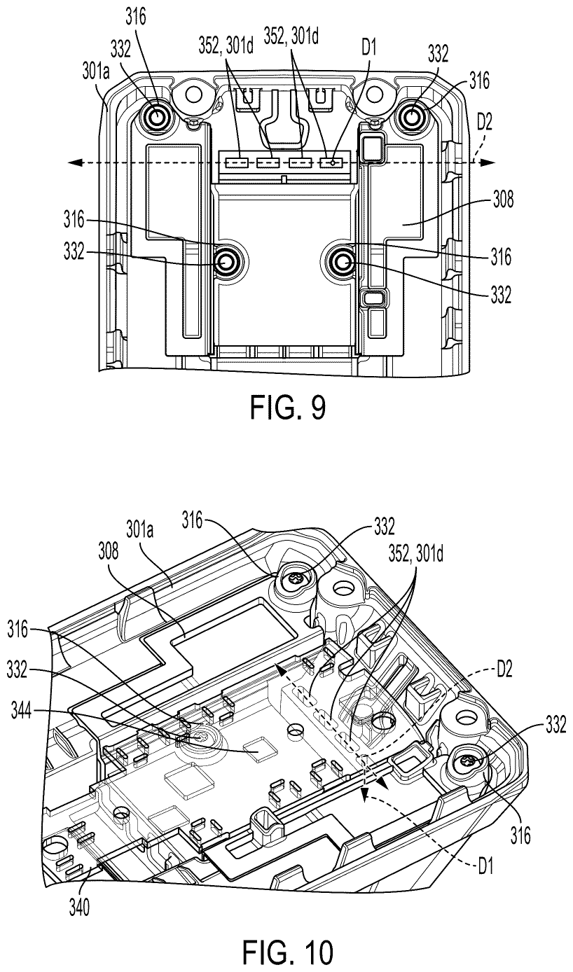

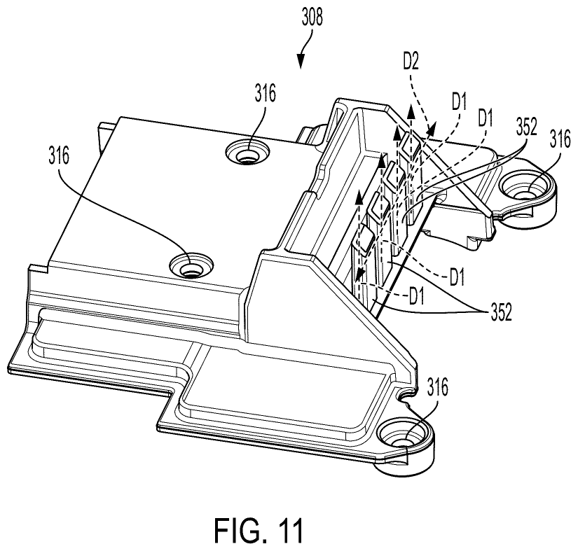

The light emitting component 348 may be one component of a plurality of light emitting components 348 on the same battery pack 300. As illustrated in FIGS. 9-11, the latch cover 308 may include four light guide portions 352. Optionally, one or more of the light guide portions 352 may be curved. The illustrated light guide portions 352 are generally linear in shape and arranged adjacent a corresponding light emitting component 348 and along a common lateral axis D2 from which each light guide portion 352 extends along a distinct parallel direction D1. However, other arrangements of light guide portions 352 including that of curved light guide portions 352 extending in directions other than the distinct parallel direction D1 are also possible. Similarly, the light emitting components 348 may be arranged in other patterns other than along the common lateral axis D2 as in the illustrated embodiment. In any case, at least a portion of the light guide portion 352 may extending in a direction transverse to the control circuit board 340. The plurality of light emitting components 348 may together be configured to emit light in a manner indicative of a state of charge of the battery cell C (or a total state of charge of the battery pack 300 as a whole considering each of the cells C). For example, four light emitting components 348 may be lit when above approximately 78% of charge remains, three light emitting components 348 may be lit when between 55% and 77% of charge remains, two light emitting components 348 may be lit when between 33% and 54% of charge remains, one light emitting component 348 may be lit when between 10% and 32% of charge remains, and one light emitting component 348 may flash when less than 10% of charge remains. Various other indicating patters of the light emitting components 348 may be employed utilizing the light emitting components 348 including but not limited to different ranges of actuating different numbers of light emitting components 348, utilizing different colored light emitting components 348, and different flash patterns of one or more light emitting components 348. The components 348 may also be turned on and/or flashed to indicate errors of the battery pack 300 and/or the connected tool or charger.

By forming the light guide portion 352 integrally with the latch cover 308, light can be transmitted from the components 348 to the exterior of the housing 301 without requiring a distinct light guide to be otherwise secured to the latch cover 308. Integrally forming the light guide portion 352 with the latch cover 308 reduces part count and complexity of assembly of the battery pack 300 while permitting light from the light emitting components 348 within the housing 301 to be visible from the exterior of the housing 301. In other embodiments, a transparent and integrally formed subhousing (subhousing 202) with a terminal cap portion (terminal cap portion 204) and a latch cover portion (latch cover portion 208) may further include an integrally formed light guide portion (see light guide portion 352).

Although the disclosure has been described in detail with reference to certain preferred embodiments, variations and modifications exist within the scope and spirit of one or more independent aspects of the disclosure as described.

What is claimed is:

1. A battery pack comprising:
a battery terminal configured to be connected to a tool;
a battery cell electrically coupled to the battery terminal;
a latch actuatable to selectively secure the battery pack to a tool;
a housing enclosing at least a portion of the latch; and
a subhousing positioned at least partially within the housing, the subhousing including a latch cover portion enclosing at least a portion of the latch therein and a terminal cap portion enclosing at least a portion of the battery terminal;
wherein the subhousing is integrally formed as a single part.

2. The battery pack of claim 1, wherein the subhousing further includes a bridge portion interconnecting the latch cover portion and the terminal cap portion.

3. The battery pack of claim 2, wherein the bridge portion includes at least one structural support rib.

4. The battery pack of claim 1, wherein the latch cover portion includes a receptacle configured to receive a fastener connecting the latch cover portion and the housing.

5. The battery pack of claim 4, wherein upon impact of the battery pack to an external surface, impact load is shared by both the latch cover portion and the terminal cap portion to relieve stress on the receptacle.

6. The battery pack of claim 1, wherein the terminal cap portion includes at least two terminal spacing ribs enclosing the battery terminal therein.

7. The battery pack of claim 1, wherein upon impact of the battery pack to an exterior surface, impact load on the subhousing is shared by both latch cover portion and the terminal cap portion.

8. The battery pack of claim 1, further comprising an electronic component therein; wherein upon impact of the battery pack to an external surface, impact load on the subhousing is shared by both the latch cover portion and the terminal cap portion to inhibit impact load transfer to the electronic component.

9. The battery pack of claim 7, wherein the latch is movable between engaged and disengaged positions to selectively secure the battery pack to the tool.

10. A battery pack comprising:
a battery terminal configured to be connected to a tool;
a battery cell electrically coupled to the battery terminal;
a latch actuatable to selectively secure the battery pack to the tool;
a housing enclosing at least a portion of the latch, the housing including at least one housing portion and a core within the housing portion defining a void within which the battery cell is positioned;
a latch cover enclosing at least a portion of the latch therein; and
a terminal cap enclosing at least a portion of the battery terminal;
wherein at least one of the latch cover or the terminal cap is ultrasonically welded to either the housing portion or the core.

11. The battery pack of claim 10, wherein the latch cover, terminal cap, and housing are ultrasonically welded to one another,
wherein upon an impact of the battery pack to an external surface, impact load is shared by the latch cover, the terminal cap, and the housing.

12. The battery pack of claim 10, wherein the housing includes a first housing portion and a second housing portion coupled to one another, the second housing portion defining a void within which the battery cell is positioned, the first housing portion and second housing portion are ultrasonically welded to one another,
whereby upon an impact of the battery pack to an external surface, impact load is shared by the first housing portion, the second housing portion, and the at least one of the latch cover or the terminal cap.

13. The battery pack of claim 12, wherein the at least one of the latch cover or the terminal cap is ultrasonically welded to the first housing portion.

14. A battery pack comprising:
a control circuit board;
a light emitting component coupled to the control circuit board;
a battery terminal electrically coupled to the control circuit board;
a battery cell electrically coupled to the battery terminal;
a latch actuatable to selectively secure the battery pack to a tool;
a housing enclosing the control circuit board and the light emitting component at least partially therein, the housing including a light guide hole passing from an interior of the housing to an exterior of the housing; and
a latch cover positioned at least partially within the housing, the latch cover enclosing at least a portion of the latch therein;
wherein the latch cover is made of a transparent material and further includes a light guide portion extending in a direction from the light emitting component in the interior of the housing and through the light guide hole such that light emitted by the light emitting component is transmitted through the light guide portion and is visible from the exterior of the housing.

15. The battery pack of claim 14, wherein the latch cover is one portion of a subhousing further including a terminal cap portion enclosing at least a portion of the battery terminal, the subhousing being transparent and integrally formed as a single part.

16. The battery pack of claim 14, wherein the latch cover and light guide portion are integrally formed with one another.

17. The battery pack of claim 14, wherein the light emitting component is configured to emit light in a manner indicative of a state of charge of the battery cell.

18. The battery pack of claim 14, wherein the light emitting component is one of a plurality of light emitting components, and the plurality of light emitting components are together configured to emit light in a manner indicative of a state of charge of the battery cell, wherein the latch cover includes a plurality of light guide portions each extending through one of a corresponding plurality of light guide holes.

19. The battery pack of claim 14, wherein the control circuit board is generally planar, and at least a portion of the light guide portion extends in a direction transverse to the control circuit board.

20. The battery pack of claim 14, wherein the housing further includes a channel defining the light guide hole, the channel extending from an exterior of the housing opposite the direction and toward the light emitting component.
